(19) United States
(12) Patent Application Publication
(10) Pub. No.: US 2026/0064182 A1
(43) Pub. Date: Mar. 5, 2026

(54) SYSTEM AND METHOD FOR CORRECTION OF HARDWARE ENTITY IDLE STATE MISPREDICTION

(71) Applicant: QUALCOMM Incorporated, San Diego, CA (US)

(72) Inventors: Dinesh Kumar CHOUDHARY, Tonk (IN); Narendra Kumar GADI, Visakhapatnam (IN); Arun Adathedath MADHAVAN, Bangalore (IN); Chandan AGARWALLA, San Diego, CA (US); Srinivas Rao LENGAMANENI, Hyderabad (IN); Maulik SHAH, Hyderabad (IN); Raja Simha REVANURU, Hyderabad (IN)

(21) Appl. No.: 18/817,084

(22) Filed: Aug. 27, 2024

(51) Int. Cl. G06F 1/3228

(52) U.S. Cl. CPC G06F 1/3228

(57) ABSTRACT

A method for correction of idle state misprediction is described. The method includes receiving an indication of a selected idle state based on a predicted sleep duration of a hardware entity. The method also includes issuing a wait for interrupt (WFI) instruction to the hardware entity to trigger entry into the selected idle state. The method further includes transitioning the hardware entity to a deeper idle state if a residency timer associated with the deeper idle state is expired prior to a wake-up of the hardware entity from the selected idle state.

### BACKGROUND

### Field

Aspects of the present disclosure relate to semiconductor devices and, more particularly, to a system and method for correction of hardware entity idle state misprediction.

### Background

Modern-day processors are equipped with multiple cores, which range from efficient, in-order-execution to super/hyper scalar architectures. The number of cores in modern-day processors has steadily risen from single (modem), dual/quad cores systems in mobile processors to an expanded number of processor cores in server compute-platforms. A system-on-chip (SoC) may include multiple processor cores/processor clusters for executing real-world applications. These real-world applications drive the complexity of SoCs due to an ever-increasing demand for additional numbers of processor cores/processor clusters for meeting performance benchmarks.

During operation, these multi-processor and multi-cluster hierarchy systems utilize multiple low power states. For example, these low power states may include clock-gating as well as power collapse, which may be global distributed head-switch (GDHS) controlled or rail controlled. These low power states are introduced at each level and have associated residency/latency specifications and depend on dynamic idle hints (e.g., predicted sleep duration). In practice, the desired idle states are selected for the different cores/clusters in the multi-processor and multi-cluster hierarchy systems based on the associated residency/latency specifications and depending on the dynamic idle hints, which can lead to idle state misprediction. A system and method for correction of processor hardware idle state misprediction is desired.

### SUMMARY

A method for correction of idle state misprediction is described. The method includes receiving an indication of a selected idle state based on a predicted sleep duration of a hardware entity. The method also includes issuing a wait for interrupt (WFI) instruction to the hardware entity to trigger entry into the selected idle state. The method further includes transitioning the hardware entity to a deeper idle state if a residency timer associated with the deeper idle state is expired prior to a wake-up of the hardware entity from the selected idle state.

An apparatus for correction of idle state misprediction is described. The apparatus includes at least one memory and at least one processor coupled to the at least one memory. The at least one processor configured to receive an indication of a selected idle state based on a predicted sleep duration of a hardware entity. The at least one processor is also configured to issue a wait for interrupt (WFI) instruction to the hardware entity to trigger entry into the selected idle state. The at least one processor is further configured to transition the hardware entity to a deeper idle state if a residency timer associated with the deeper idle state is expired prior to a wake-up of the hardware entity from the selected idle state.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-chip (SoC), which is configured for correction of hardware entity idle state misprediction, in accordance with various aspects of the present disclosure.

FIG. 2 is a block diagram illustrating a central processing unit (CPU) subsystem (CPUSS) of the system-on-chip (SoC) of FIG. 1, including trusted firmware to support correction of hardware entity idle state misprediction, according to various aspects of the present disclosure.

FIG. 3 is a block diagram further illustrating heterogenous architecture cores of the CPUSS of the system-on-chip (SoC) of FIG. 2, including trusted firmware to support correction of hardware entity idle state misprediction, according to various aspects of the present disclosure.

FIG. 4 is a process flow diagram illustrating hardware-based correction of hardware entity idle state misprediction, according to various aspects of the present disclosure.

FIG. 5 is a process flow diagram illustrating software-based correction of hardware entity idle state misprediction, according to various aspects of the present disclosure.

FIG. 6 is a process flow diagram illustrating a method for correction of hardware entity idle state misprediction, according to various aspects of the present disclosure.

FIG. 7 is a block diagram showing an exemplary wireless communications system in which an aspect of the disclosure may be advantageously employed.

FIG. 8 is a block diagram illustrating a design workstation used for circuit, layout, and logic design of a semiconductor component, such as the disclosed correction of hardware entity idle state misprediction.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations. It will be understood that the term “layer” includes film and is not construed as indicating a vertical or horizontal thickness unless otherwise stated. As described, the term “substrate” may refer to a substrate of a diced wafer or may refer to a substrate of a wafer that is not diced. Similarly, the terms “chip” and “die” may be used interchangeably.

During operation, multi-processor and multi-cluster hierarchy systems utilize multiple low power states. For example, these low power states may include clock-gating as well as power collapse, which may be global distributed head-switch (GDHS) controlled or rail controlled. These low power states are introduced at each level and have associated residency/latency specifications and depend on dynamic idle hints (e.g., predicted sleep duration). In practice, the desired idle states are selected for the different cores/clusters in the multi-processor/multi-cluster hierarchy systems based on the associated residency/latency specifications and depend on the dynamic idle hints, which can lead to idle state misprediction.

Improved idle state prediction is useful for both power and performance in multi-processor/multi-cluster hierarchy systems, in which utilization of a deeper state beneficially impacts both power and performance dashboards. Unfortunately, the dynamic nature of multi-processor/multi-cluster hierarchy systems complicates the prediction of future sleep durations of the hardware entities of these systems. In particular, the prediction of future sleep durations is not an exact science and is further dependent on algorithms utilized by an operating system (OS)/kernel. In a perfect world, kernel low power management (LPM) prediction algorithms account for mispredictions and improve the LPM selection accuracy. Unfortunately, accounting for mispredictions increases LPM selection overhead and detrimentally impacts LPM matrices used for LPM selection. Additionally, coordination of platform states involves synchronization to ensure visibility of the other cores under the topology, which further increases the LPM selection overhead.

In conventional LPM selection, when a predicted wake-up (e.g., sleep duration) associated with a selected idle state does not occur, the processor remains in the selected idle state, which is non-optimal because a deeper state could have been selected. Additionally, conventional kernel LPM selection solutions force a wake-up and reevaluate the selected idle state, which incurs significant overhead caused by a complete software (SW)/hardware (HW) exit from a current idle state and entry to a reevaluated state. A system and method for correction of hardware entity idle state misprediction is desired.

According to various aspects of the present disclosure, correction of idle state misprediction is triggered when a selected idle state for a hardware entity (e.g., a processor core/cluster) is based on a misprediction of a future sleep duration. In these aspects of the present disclosure, correction of the selected idle state involves auto transitioning the hardware entity from the selected idle state to a deeper idle state. In some implementations, an intelligent hardware state machine is configured to determine when to enter in deeper mode then currently selected.

In some implementations, auto transitioning the hardware entity from the selected idle state to a deeper idle state is performed once a hysteresis timer associated with the deeper idle state expires. Auto transitioning to the deeper idle state once the hysteresis timer associated with the deeper idle state expires results in improved power savings. Additionally, reevaluation of the idle state is eliminated, which cancels the entire overhead associated with exit from the selected idle state and reentry into the deeper idle state. According to various aspects of the present disclosure, a kernel or operating system agnostic solution for rail power collapse is incorporated within proprietary trusted firmware and hardware.

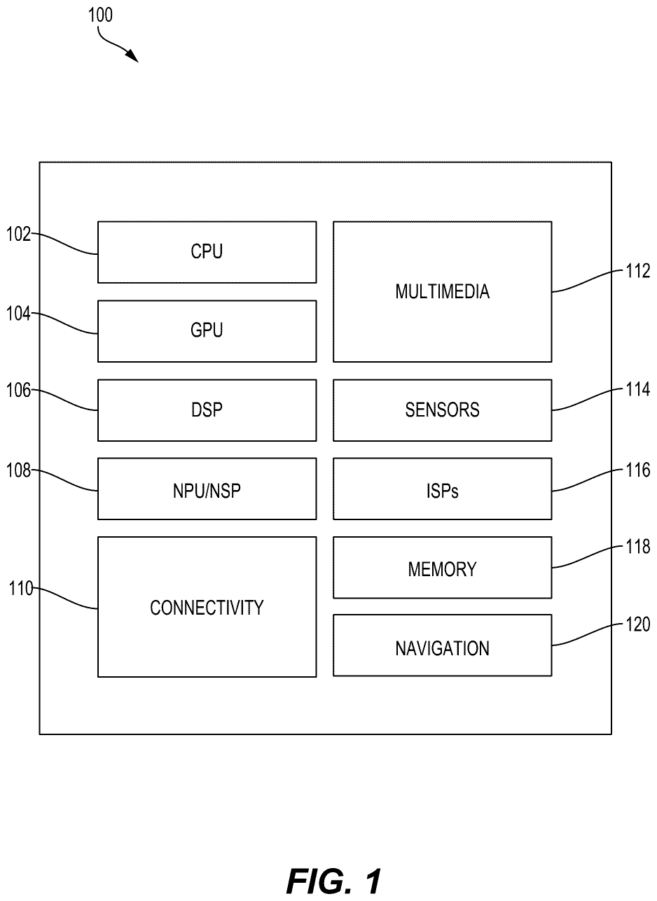

FIG. 1 illustrates an example implementation of a host system-on-chip (SoC) 100, which is configured for correction of hardware entity idle state misprediction, in accordance with aspects of the present disclosure. The host SoC 100 includes processing blocks tailored to specific functions, such as a connectivity block 110. The connectivity block 110 may include sixth generation (6G), connectivity fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU)/neural signal processor (NSP) 108. The host SoC 100 may also include a sensor processor 114, image signal processors (ISPs) 116, a navigation module 120, which may include a global positioning system, and a memory 118. The multi-core CPU 102, the GPU 104, the DSP 106, the NPU/NSP 108, and the multimedia engine 112 support various functions such as video, audio, graphics, gaming, artificial networks, and the like. Each processor core of the multi-core CPU 102 may be a reduced instruction set computing (RISC) machine, RISC-V, an advanced RISC machine (ARM), a microprocessor, or any reduced instruction set computing (RISC) architecture. The NPU/NSP 108 may be based on an ARM instruction set.

The multi-core CPU 102 is equipped with multiple cores, which may range from efficient, in-order-execution to super/hyper scalar architectures. The number of cores in the multi-core CPU 102 may range from eight (8) processor cores in a mobile processor implementation to ninety-six (96) processor cores in a server compute-platform implementation of the host SoC 100. The host SoC 100 may include multiple processor cores/processor clusters executing real-world applications. The real-world applications drive the complexity of the host SoC 100 due to an ever-increasing demand for additional numbers of processor cores/processor clusters for meeting performance benchmarks.

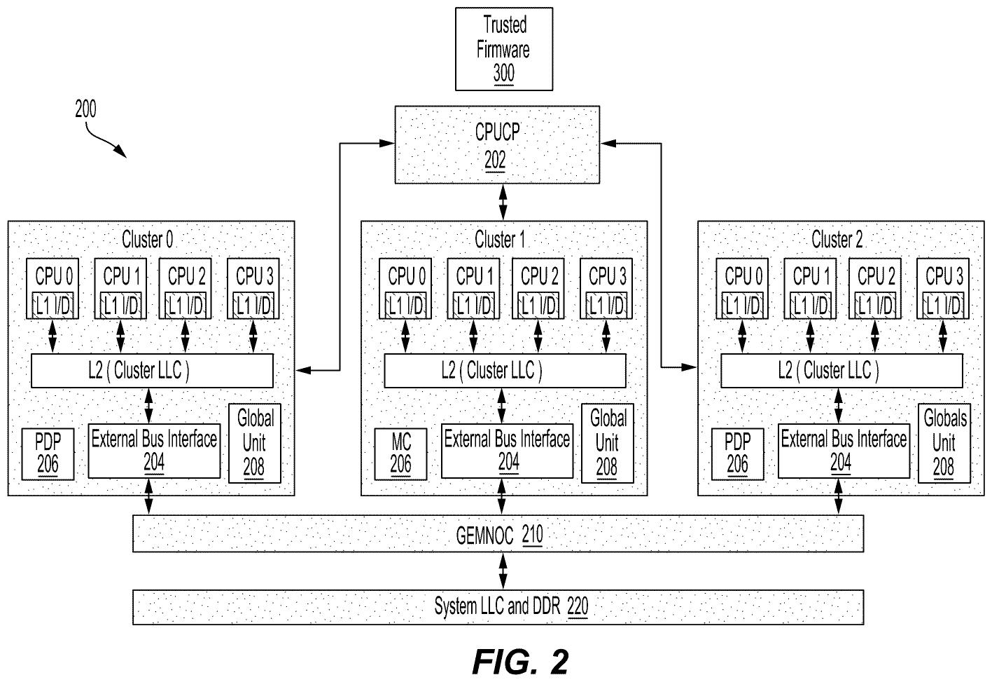

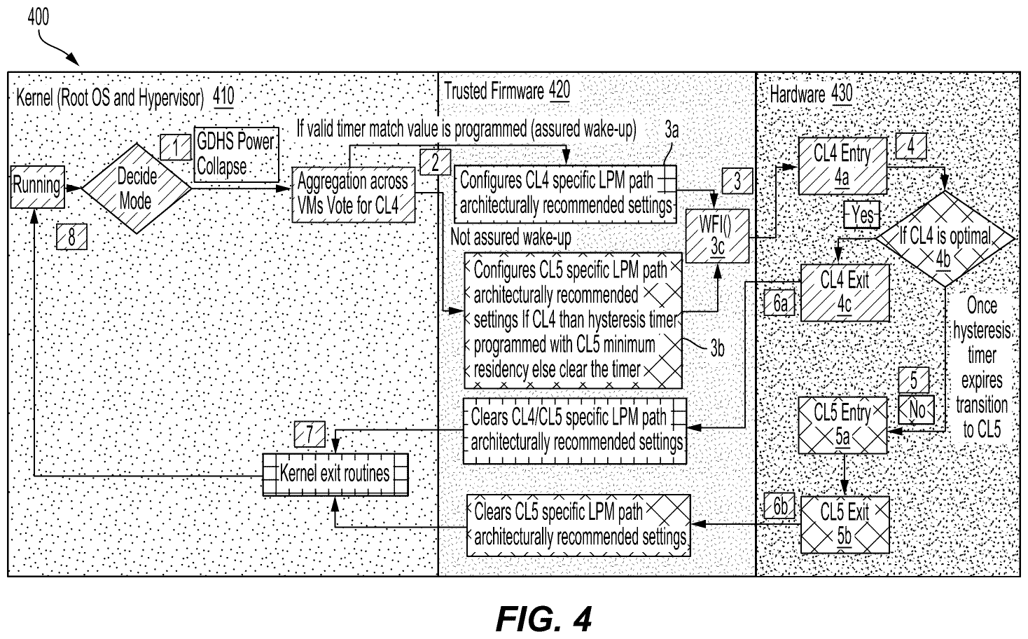

FIG. 2 is a circuit diagram illustrating a central processing unit (CPU) subsystem (CPUSS) 200, for example, of the system-on-chip (SoC) of FIG. 1, including trusted firmware 300 to support correction of hardware entity idle state misprediction, according to various aspects of the present disclosure. As shown in FIG. 2, the CPUSS 200 includes a CPUSS control processor (CPUCP) 202 of CPU clusters (e.g., Cluster 0, Cluster 1, Cluster 2). In this implementation, each CPU cluster includes a set of four CPUs (e.g., CPU0, CPU1, CPU2, CPU3). Other implementations may include a different number of CPUs. According to various aspects of the present disclosure, the CPUSS 200 includes the trusted firmware 300 configured for correcting hardware entity idle state misprediction, as further described in FIG. 4.

As further illustrated in FIG. 2, each CPU cluster includes a large resolute per-cluster last level cache (LLC) (e.g., L2 (Cluster LLC)) coupled to an external bus interface 204. Additionally, each CPU cluster includes a micro-controller (MC 206) based firmware solution for managing cluster specific power and debug infrastructure and a global unit 208 configured to manage CPU hardware (e.g., phase locked loops (PLLs), a power controller, etc.) as well as multiple hardware trackers. In various aspects of the present disclosure, the global unit 208 manages a single PLL for the set of CPUs and the cluster LLC of each CPU cluster. Additionally, a network-on-chip (NoC) 210 provides a fabric and coherence point for each CPU cluster to access a system memory 220 (e.g., system LLC and double-data-rate (DDR) memory).

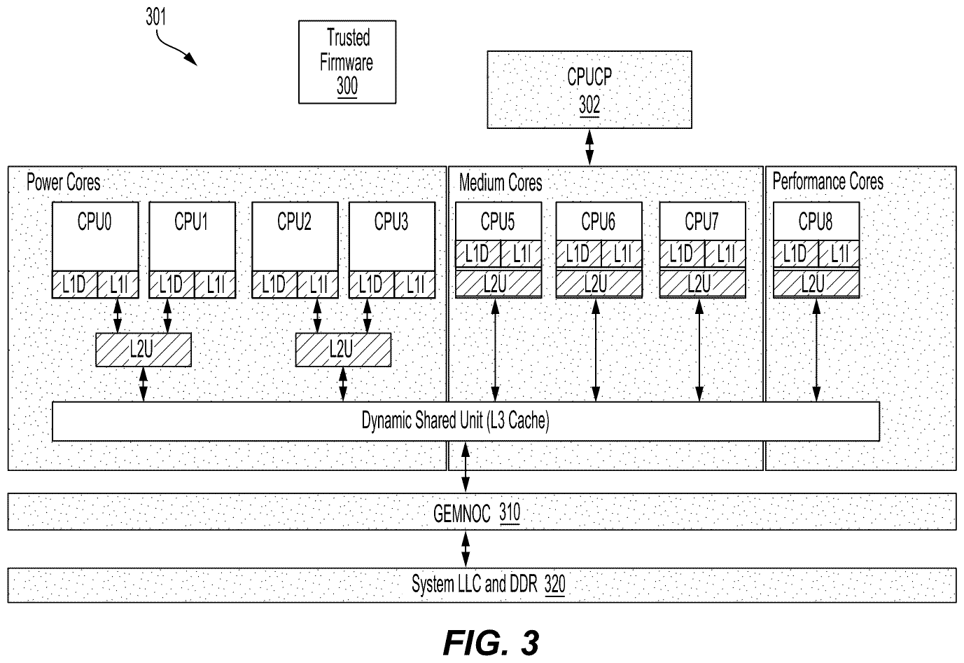

FIG. 3 is a block diagram further illustrating heterogenous architecture cores of the CPUSS of the system-on-chip (SoC) of FIG. 2, including trusted firmware 300 to support correction of hardware entity idle state misprediction, according to various aspects of the present disclosure. As shown in FIG. 3, a central processing unit (CPU) subsystem (CPUSS) 301 includes a CPUSS control processor (CPUCP) 302 of eight (8) CPUs (e.g., CPU0, CPU1, CPU2, CPU3, CPU5, CPU6, CPU7, CPU8) assigned to either a power core, a medium core, or a performance core). In this implementation, the power core is assigned four (4) CPUs (e.g., CPU0, CPU1, CPU2, CPU3), the medium core is assigned three (3) CPUs (e.g., CPU5, CPU6, CPU7), and the performance core is assigned one (1) CPU. In other implementations, the CPUSS 301 may include a different number of CPUs as well as different core assignments.

As further illustrated in FIG. 3, each CPU includes a level one data (L1D) cache and a level two instruction (L2I) cache coupled to a level two (L2) unified (L2U) cache. In this example, the power core operates according to a separate frequency source and shares an L2U cache between CPU0 and CPU1 and an L2U cache between CPU2 and CPU3 as well as a voltage domain with a level three (L3) cache. The CPUs of the medium core and the performance core include a resolute L2U cache to directly access the L3 cache (e.g., a dynamic shared unit). Additionally, the CPUs of the medium core and the performance core operate according to separate frequency sources but share a voltage domain. Alternatively, the CPUs of the medium core and the performance core operate according to separate frequency sources as well as different voltage domains.

In various aspects of the present disclosure, a network-on-chip (NoC) 310 provides a fabric and coherence point for access to a system memory 320 (e.g., system last level cache (LLC) and double-data-rate (DDR) memory). According to various aspects of the present disclosure, the CPUSS 301 includes the trusted firmware 300 configured for correction of idle state misprediction, as further described in FIG. 4.

During operation, the multi-processor and multi-cluster hierarchy systems of the CPUSS 200/301 utilize multiple low power states. For example, these low power states may include clock-gating as well as power collapse, which may be global distributed head-switch (GDHS) controlled or rail controlled. These low power states are introduced at each level and have associated residency/latency specifications and depend on dynamic idle hints (e.g., predicted future sleep duration of a hardware entity). In practice, the desired idle states are selected for the different cores/clusters in the multi-processor/multi-cluster hierarchy systems of the CPUSS 200/301 based on the associated residency/latency specifications and depend on the dynamic idle hints, which can lead to idle state misprediction. As described, an idle hint may refer to a predicted future sleep duration of a hardware entity (e.g., the cores/clusters in the multi-processor/multi-cluster hierarchy systems of the CPUSS 200/301) utilized for idle state selection.

Improved idle state selection is useful for both power and performance in the multi-processor/multi-cluster hierarchy systems of the CPUSS 200/301. Utilization of a deeper state beneficially impacts both power and performance dashboards of the CPUSS 200/301. Unfortunately, the dynamic nature of the multi-processor/multi-cluster hierarchy systems of the CPUSS 200/301 complicates the prediction of future sleep durations of the noted hardware entities. In particular, the prediction of future sleep durations is not an exact science and is further dependent on algorithms utilized by an operating system (OS)/kernel of the CPUSS 200/301. In a perfect world, kernel low power management (LPM) prediction accounts for mispredictions and improves the LPM selection accuracy. Unfortunately, accounting for mispredictions increases LPM selection overhead and detrimentally impacts LPM matrices used for LPM selection. Additionally, coordination of platform states involves synchronization to ensure visibility of the other cores under the topology, which further increases the LPM selection overhead.

In conventional LPM idle state selection, when a predicted wake-up (e.g., sleep duration) associated with a selected idle state does not occur, the processor remains in the selected idle state, which is non-optimal because a deeper state could have been selected. For example, a predicted future sleep duration (e.g., 3.125 milliseconds) of a processor core is used to select an idle state (e.g., a shallow collapsed power idle state (CL4)). Unfortunately, when the actual sleep duration (e.g., 13-15 milliseconds) exceeds the predicted future sleep duration (e.g., 3.125 milliseconds), a misprediction of the future sleep duration is detected. This misprediction of the future sleep duration results in the selection of shallow idle state (e.g., CL4) when in a deeper idle state (e.g., a deep collapsed power idle state (CL5)). That is, the deeper idle state (e.g., a deep collapsed power idle state (CL5)) should have been selected instead of the shallow idle state (e.g., CL4). Additionally, conventional kernel LPM selection solutions force a wake-up and reevaluate the selected idle state, which incurs significant overhead caused by a complete software (SW)/hardware (HW) exit from the selected idle state and entry into a reevaluation state. A system and method for correction of hardware entity idle state misprediction is desired.

According to various aspects of the present disclosure, correction of hardware entity idle state misprediction is triggered when a selected idle state for a hardware entity (e.g., a processor core/cluster of the CPUSS 200/301) is based on a misprediction of a future sleep duration of the hardware entity. In these aspects of the present disclosure, correction of the selected idle state involves auto transitioning the hardware entity from the selected idle state to a deeper idle state once a hysteresis timer associated with the deeper idle state expires. Auto transitioning to the deeper idle state once the hysteresis timer associated with the deeper idle state expires results in improved power savings. Additionally, reevaluation of the selected idle state is eliminated, which cancels the entire overhead associated with exit from the selected idle state and reentry into the deeper idle state. According to various aspects of the present disclosure, a Kernel or operating system agnostic solution for rail power collapse is incorporated within the trusted firmware 300, which is further illustrated in FIG. 4.

FIG. 4 is a process flow diagram 400 illustrating hardware-based correction of hardware entity idle state misprediction, according to various aspects of the present disclosure. As shown in the process flow diagram 400, at step 1, a kernel 410 (e.g., root operating system (OS) and Hypervisor) selects an idle state (e.g., CL4 power collapse mode/CL5 power collapse mode) for a hardware entity 430 based on a predicted sleep hint and a latency tolerance limit according to current system dynamics as part of a low power management (LPM) process. In various aspects of the present disclosure, the kernel 410 selects between multiple low power idle states (e.g., CL4 power collapse mode or CL5 power collapse mode). For example, these low power idle states may include clock-gating as well as power collapse, which may be global distributed head-switch (GDHS) controlled (e.g., GDHS power collapse) or rail controlled (e.g., rail power collapse).

At step 2, the kernel 410 aggregates votes for the selected idle state across all running virtual machines as part of the LPM process. Additionally, the kernel 410 issues a secure monitor call (SMC) to trusted firmware 420 through a power system coordination interface (PSCI) in response to aggregating the votes for the selected idle state across all the running virtual machines at step 2.

According to various aspects of the present disclosure, the trusted firmware 420 determines whether a valid timer match value is configured to wake the hardware entity 430 based on the selected idle state (e.g., CL4 power collapse mode). When a valid timer match value is detected, at step 3a, the trusted firmware 420 configures a selected idle state low power mode (LPM) path based on architecturally recommended settings. Otherwise, an infinite timer match value is detected due to an unassured wake-up of the hardware entity 430 and, at step 3b, the trusted firmware 420 configures a deeper idle state (e.g., CL5 power collapse mode) LPM path based on architecturally recommended settings. Additionally, the trusted firmware 420 programs a hysteresis timer (e.g., residence timer) with a minimum residency value specified by the deeper idle state (e.g., CL5 power collapse mode). At step 3c, the trusted firmware 420 executes a wait for interrupt (WFI) operation to the hardware entity 430.

At steps 4a-4c, the processor core and cluster power state machines (PSM) execute the specified LPM entry/exit sequences (4a and 4c) for the selected LPM idle state if the selected LPM idle state is determined as an optimal idle state at step 4b.

Otherwise, a predicted interrupt based on the WFI instruction at step 3c has not occurred and a hysteresis timer expires at block 4b. In response to detecting expiration of the hysteresis timer, the hardware entity 430 transitions to the deeper idle state (e.g., CL5 power collapse mode) by performing the LPM entry/exit sequences for the deeper idle state at steps 5a and 5b.

As further illustrated in FIG. 4, the trusted firmware 420 clears the configured idle state LPM path of the hardware entity 430 (e.g., CL4 power collapse mode or CL5 power collapse mode). For example, at step 6a, the trusted firmware 540 clears the selected idle state (e.g., CL4 power collapse mode) specific LPM path configuration if a valid timer match value is programmed (see step 3a). Otherwise, at step 6b, the trusted firmware 420 clears the deeper idle state (e.g., CL5 power collapse mode) specific LPM path configuration if an assured wake-up is not scheduled. At step 7, the kernel 410 runs LPM exit specific routines. At step 8, the hardware entity 430 returns to the kernel 410 and executes scheduled tasks.

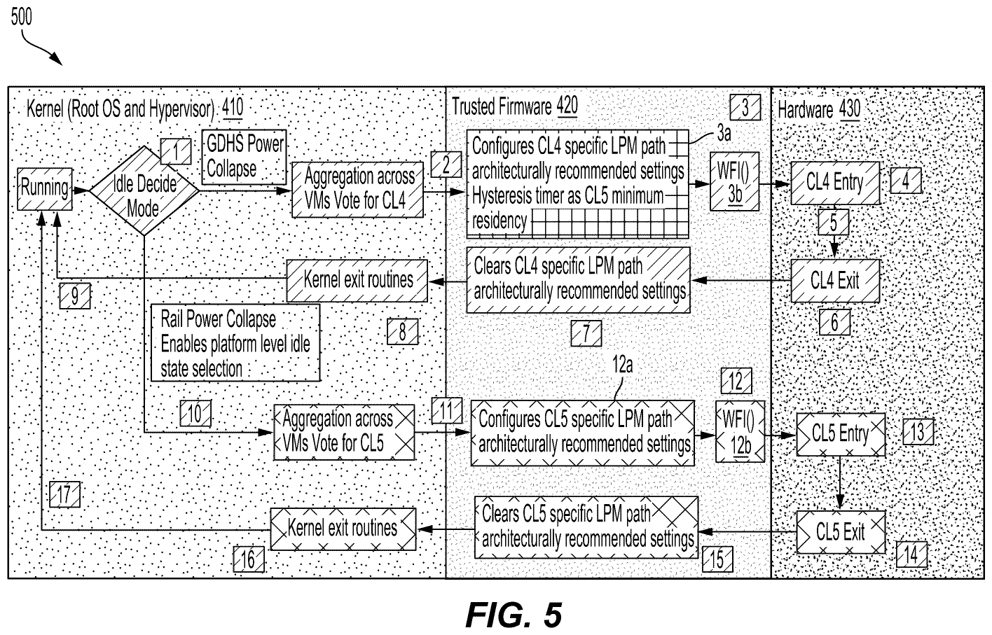

FIG. 5 is a process flow diagram 500 illustrating software-based correction of hardware entity idle state misprediction, according to various aspects of the present disclosure. The process flow diagram 500 is like the process flow diagram 400 shown in FIG. 4 and is described using similar reference numbers. In the process flow diagram 500 of FIG. 5, however, the kernel 410 decides between a global distributed head-switch (GDHS) power collapse mode at step 1 and a rail power collapse mode at step 10 for scheduling an idle thread.

As shown in the process flow diagram 500, at step 1, the kernel 410 selects an idle state (e.g., the CL4 power collapse mode or the CL5 power collapse mode) for the hardware entity 430 based on the predicted sleep hint and the latency tolerance limit according to the current dynamics of the hardware entity 430 as part of a low power management (LPM) process. In various aspects of the present disclosure, the kernel 410 selects between multiple low power idle states (e.g., the CL4 power collapse mode or CL5 power collapse mode). For example, these low power idle states may include clock-gating as well as power collapse, which may be GDHS controlled (e.g., GDHS power collapse shown in step 1) or rail controlled (e.g., rail power collapse shown in step 10).

At step 2, the kernel 410 aggregates votes for the selected idle state across all running virtual machines as part of the LPM process. Additionally, the kernel 410 issues a secure monitor call (SMC) to the trusted firmware 420 through a power system control interface (PSCI) in response to aggregating the votes for the selected idle state across all the running virtual machines at step 2. At step 3a, the trusted firmware 420 configures the selected idle state (e.g., CL4 power collapse mode) specific LPM path based on architecturally recommended settings. Additionally, the trusted firmware 420 programs a hysteresis timer with a minimum residency value specified by the deeper idle state (e.g., the CL5 power collapse mode). At step 3b, the trusted firmware 420 executes a wait for interrupt (WFI) operation to the hardware entity 430.

At steps 4-6, processor core and cluster power state machines (PSM) execute the specified LPM entry/exit sequences for the selected idle state (e.g., CL4 power collapse mode). Otherwise, when a predicted interrupt based on the WFI instruction at step 3c has not occurred and a hysteresis timer expires, at block 5 a forced wake-up of the hardware entity 430 is performed. Once the hysteresis timer expires, the hardware entity 430 exits the selected idle at block 6.

As further illustrated in FIG. 5, the trusted firmware 420 clears the selected idle state (e.g., CL4 power collapse mode) specific LPM path architecturally recommended settings at step 7. At step 8, the kernel 410 runs the LPM process exit specific routines. At step 9, the hardware entity 430 returns to the kernel 410 and is available for task scheduling.

As shown in the process flow diagram 500, at step 10, the Kernel 410 selects an idle state (e.g., the CL5 power collapse mode) based on a rail power collapse for the hardware entity 430 to provide a platform level idle state selection as part of an LPM process. At step 11, the kernel 410 aggregates votes for the selected idle state (e.g., the CL5 power collapse mode) across all running virtual machines as part of the LPM process. Additionally, the kernel 410 issues a secure monitor call (SMC) to the trusted firmware 420 through a PSCI in response to aggregating the votes for the selected idle state (e.g., the CL5 power collapse mode) across all the running virtual machines at step 11.

At step 12a, the trusted firmware 420 configures the selected idle state (e.g., CL5 power collapse mode) specific LPM path based on architecturally recommended settings. At step 12b, the trusted firmware 420 executes a WFI operation to the hardware entity 430. At steps 13-14, the processor core and cluster PSM execute the specified LPM entry/exit sequences for the selected idle state (e.g., CL5 power collapse mode). Once the interrupt is asserted, the hardware entity 430 exits the selected idle state at block 14.

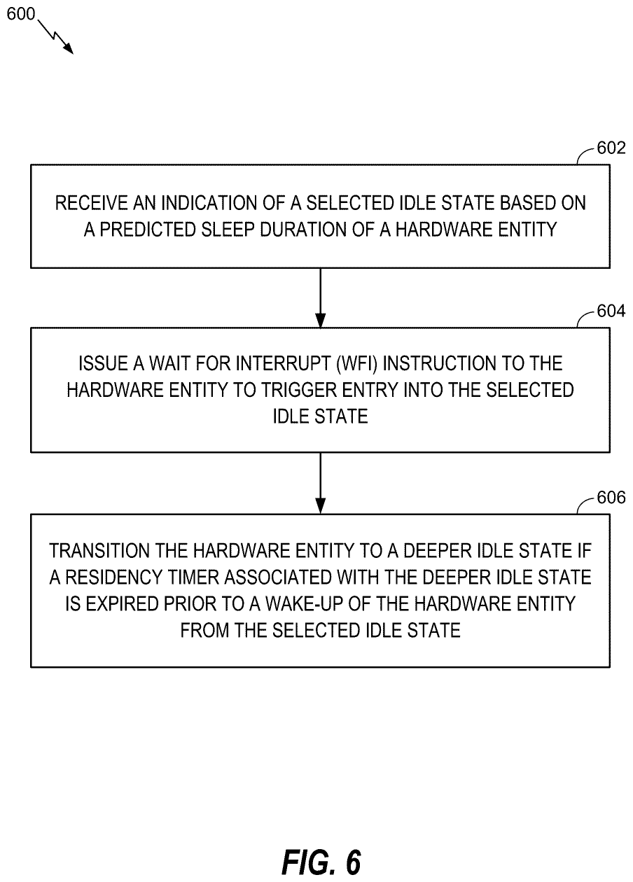

As further illustrated in FIG. 5, the trusted firmware 420 clears the selected idle state (e.g., CL5 power collapse mode) specific LPM path architecturally recommended settings at step 15. At step 16, the kernel 410 runs the LPM process exit specific routines. At step 17, the hardware entity 430 returns to the kernel 410 and is available for task scheduling. A method for correction of hardware entity idle state misprediction may be performed, for example, as shown in FIG. 6.

FIG. 6 is a process flow diagram illustrating a method 600 for correction of hardware entity idle state misprediction, according to various aspects of the present disclosure. The method 600 begins at block 602, in which an indication is received of a selected idle state based on a predicted sleep duration of a hardware entity. For example, FIG. 4 shows in the process flow diagram 400 in which, at step 1, a kernel 410 (e.g., root operating system (OS) and Hypervisor) selects an idle state (e.g., CL4 power collapse mode/CL5 power collapse mode) for a hardware entity 430 based on a predicted sleep hint and a latency tolerance limit according to current system dynamics as part of a low power management (LPM) process.

At block 604, a wait for interrupt (WFI) instruction is issued to the hardware entity to trigger entry into the selected idle state. For example, as shown in FIG. 4, the trusted firmware 420 programs a hysteresis timer (e.g., residence timer) with a minimum residency value specified by the deeper idle state (e.g., CL5 power collapse mode). At step 3c, the trusted firmware 420 executes a wait for interrupt (WFI) operation to the hardware entity 430.

At block 606, the hardware entity is transitioned to a deeper idle state if a residency timer associated with the deeper idle state is expired prior to a wake-up of the hardware entity from the selected idle state. For example, as shown in FIG. 4, a predicted interrupt based on the WFI instruction at step 3c has not occurred and a hysteresis timer expires at block 4b. In response to detecting expiration of the hysteresis timer, the hardware entity 430 transitions to the deeper idle state (e.g., CL5 power collapse mode) by performing the LPM entry/exit sequences for the deeper idle state at steps 5a and 5b.

In some aspects, the method 600 may be performed by the host SoC 100 (FIG. 1). That is, each of the elements of method 600 may, for example, but without limitation, be performed by the host SoC 100 or one or more processors (e.g., multi-core CPU 102 and/or NPU 130) and/or other components included therein.

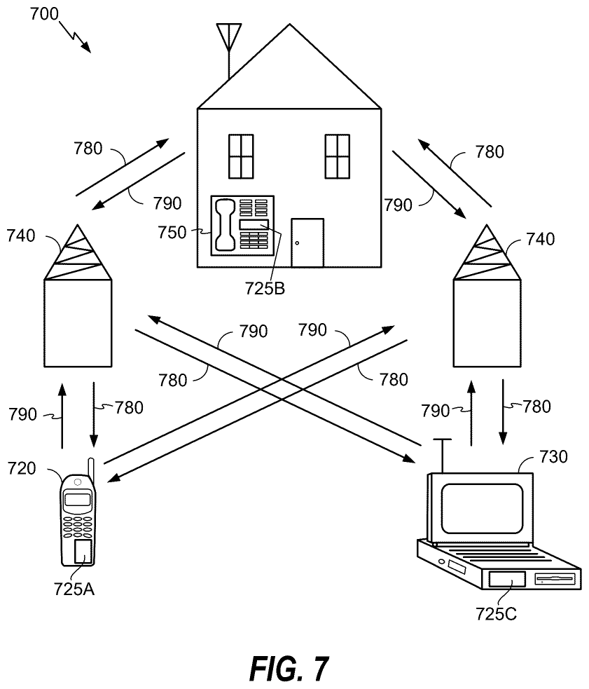

FIG. 7 is a block diagram showing an exemplary wireless communications system 700 in which an aspect of the disclosure may be advantageously employed. For purposes of illustration, FIG. 7 shows three remote units 720, 730, and 750, and two base stations 740. It will be recognized that wireless communications systems may have many more remote units and base stations. Remote units 720, 730, and 750 include IC devices 725A, 725B, and 725C that include the disclosed correction of hardware entity idle state misprediction. It will be recognized that other devices may also include the disclosed correction of hardware entity idle state misprediction, such as the base stations, switching devices, and network equipment. FIG. 7 shows forward link signals 780 from the base stations 740 to the remote units 720, 730, and 750, and reverse link signals 790 from the remote units 720, 730, and 750 to base stations 740.

In FIG. 7, remote unit 720 is shown as a mobile telephone, remote unit 730 is shown as a portable computer, and remote unit 750 is shown as a fixed location remote unit in a wireless local loop system. For example, the remote units may be a mobile phone, a hand-held personal communications systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 7 illustrates remote units according to aspects of the present disclosure, the disclosure is not limited to these exemplary illustrated units. Aspects of the present disclosure may be suitably employed in many devices, which include the disclosed correction of hardware entity idle state misprediction.

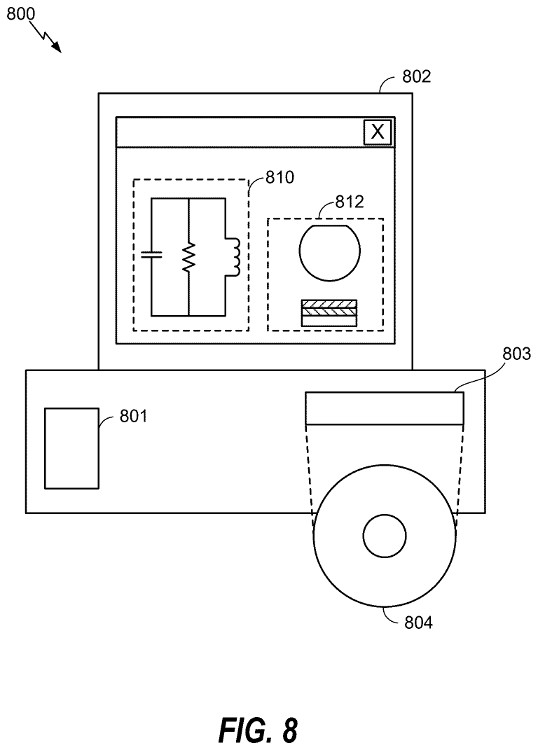

FIG. 8 is a block diagram illustrating a design workstation used for circuit, layout, and logic design of a semiconductor component, such as the correction of hardware entity idle state misprediction disclosed above. A design workstation 800 includes a hard disk 801 containing operating system software, support files, and design software such as Cadence or OrCAD. The design workstation 800 also includes a display 802 to facilitate design of a circuit 810 or an integrated circuit (IC) component 812 such as the interrupt controller. A storage medium 804 is provided for tangibly storing the design of the circuit 810 or the IC component 812 (e.g., the interrupt controller for processor hardware packaging and architecture aware interrupt routing). The design of the circuit 810 or the IC component 812 may be stored on the storage medium 804 in a file format such as GDSII or GERBER. The storage medium 804 may be a CD-ROM, DVD, hard disk, flash memory, or other appropriate device. Furthermore, the design workstation 800 includes a drive apparatus 803 for accepting input from or writing output to the storage medium 804.

Data recorded on the storage medium 804 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 804 facilitates the design of the circuit 810 or the IC component 812 by decreasing the number of processes for designing semiconductor wafers.

Implementation examples are described in the following numbered clauses:
1. A method for correction of idle state misprediction, the method comprising:
receiving an indication of a selected idle state based on a predicted sleep duration of a hardware entity;
issuing a wait for interrupt (WFI) instruction to the hardware entity to trigger entry into the selected idle state; and
transitioning the hardware entity to a deeper idle state if a residency timer associated with the deeper idle state is expired prior to a wake-up of the hardware entity from the selected idle state.
2. The method of clause 1, further comprising forcing the wake-up of the hardware entity from the selected idle state when the residency timer is expired.
3. The method of any of clauses 1 or 2, in which issuing the WFI comprises:
determining, by trusted firmware (TF), if a valid timer match value is configured to wake the hardware entity; and
configuring a low power mode (LPM) path of the hardware entity according to the selected idle state when the valid timer match value is determined.
4. The method of any of clauses 1 or 2, in which issuing the WFI comprises:
determining, by trusted firmware (TF), if a valid timer match value is configured to wake the hardware entity;
configuring a low power mode (LPM) path of the hardware entity according to the deeper idle state when an infinite timer match value is determined; and
setting the residency timer of the hardware entity according to the deeper idle state.
5. The method of any of clauses 1-4, in which transitioning the hardware entity to the deeper idle state comprises:
detecting expiration of the residency timer during hibernation of the hardware entity according to the selected idle state; and
directing entry of the hardware entity into the deeper idle state.
6. The method of clause 5, further comprising clearing a low power mode (LPM) path of the hardware entity in response to the wake-up of the hardware entity from the deeper idle state.
7. The method of any of clauses 1-6, in which issuing the WFI comprises:
configuring a low power mode (LPM) path of the hardware entity corresponding to the selected idle state; and
setting the residency timer of the hardware entity according to the deeper idle state.
8. The method of any of clauses 1-7, in which the transitioning comprises:
detecting expiration of the residency timer during hibernation of the hardware entity according to the selected idle state; and
forcing the wake-up of the hardware entity.
9. The method of any of clauses 1-8, further comprising:
detecting a rail power collapse idle mode;
configuring a low power mode (LPM) path of the hardware entity corresponding to the deeper idle state; and
directing entry of the hardware entity into the deeper idle state.
10. The method of any of clauses 1-9, in which the predicted sleep duration of the hardware entity exceeds the sleep duration associated with the selected idle state if the timer associated with the deeper idle state is expired prior to the wake-up of the hardware entity from the selected idle state.
11. An apparatus, comprising:
at least one memory; and
at least one processor coupled to the at least one memory, the at least one processor configured to:
   receive an indication of a selected idle state based on a predicted sleep duration of a hardware entity;
   issue a wait for interrupt (WFI) instruction to the hardware entity to trigger entry into the selected idle state; and
   transition the hardware entity to a deeper idle state if a residency timer associated with the deeper idle state is expired prior to a wake-up of the hardware entity from the selected idle state.
12. The apparatus of clause 11, in which the at least one processor is further configured to force the wake-up of the hardware entity from the selected idle state when the residency timer is expired.
13. The apparatus of any of clauses 11 or 12, in which to issue the WFI, the at least one processor is further configured to:
determine, by trusted firmware (TF), if a valid timer match value is configured to wake the hardware entity; and
configure a low power mode (LPM) path of the hardware entity according to the selected idle state when the valid timer match value is determined.
14. The apparatus of any of clauses 11 or 12, in which to issue the WFI, the at least one processor is further configured to:
determine, by trusted firmware (TF), if a valid timer match value is configured to wake the hardware entity;
configure a low power mode (LPM) path of the hardware entity according to the deeper idle state when an infinite timer match value is determined; and
set the residency timer of the hardware entity according to the deeper idle state.
15. The apparatus of any of clauses 11-14, in which to transition the hardware entity to the deeper idle state, the at least one processor is further configured to:
detect expiration of the residency timer during hibernation of the hardware entity according to the selected idle state; and
direct entry of the hardware entity into the deeper idle state.
16. The apparatus of clause 15, in which the at least one processor is further configured to clear a low power mode (LPM) path of the hardware entity in response to the wake-up of the hardware entity from the deeper idle state.
17. The apparatus of any of clauses 11-16, in which to issue the WFI, the at least one processor is further configured to:
configure a low power mode (LPM) path of the hardware entity corresponding to the selected idle state; and
set the residency timer of the hardware entity according to the deeper idle state.
18. The apparatus of any of clauses 11-17, in which to transition, the at least one processor is further configured to:
detect expiration of the residency timer during hibernation of the hardware entity according to the selected idle state; and
force the wake-up of the hardware entity.
19. The apparatus of any of clauses 11-18, in which the at least one processor is further configured to:
detect a rail power collapse idle mode;
configure a low power mode (LPM) path of the hardware entity corresponding to the deeper idle state; and
direct entry of the hardware entity into the deeper idle state.
20. The apparatus of any of clauses 11-19, in which the predicted sleep duration of the hardware entity exceeds the sleep duration associated with the selected idle state if the residency timer associated with the deeper idle state is expired prior to the wake-up of the hardware entity from the selected idle state.

For a firmware and/or software implementation, the methodologies may be implemented with modules (e.g., procedures, functions, etc.) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used herein, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present application is not intended to be limited to the configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform the same function or achieve the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosure is provided to enable any person skilled in the art to make or use the disclosure. Various modifications to the disclosure will be readily apparent to those skilled in the art, and the generic principles defined may be applied to other variations without departing from the spirit or scope of the disclosure. Thus, the disclosure is not intended to be limited to the examples and designs described but is to be accorded the widest scope consistent with the principles and novel features disclosed.

What is claimed is:

1. A method for correction of idle state misprediction, the method comprising:
receiving an indication of a selected idle state based on a predicted sleep duration of a hardware entity;
issuing a wait for interrupt (WFI) instruction to the hardware entity to trigger entry into the selected idle state; and
transitioning the hardware entity to a deeper idle state if a residency timer associated with the deeper idle state is expired prior to a wake-up of the hardware entity from the selected idle state.

2. The method of claim 1, further comprising forcing the wake-up of the hardware entity from the selected idle state when the residency timer is expired.

3. The method of claim 1, in which issuing the WFI comprises:
determining, by trusted firmware (TF), if a valid timer match value is configured to wake the hardware entity; and
configuring a low power mode (LPM) path of the hardware entity according to the selected idle state when the valid timer match value is determined.

4. The method of claim 1, in which issuing the WFI comprises:
determining, by trusted firmware (TF), if a valid timer match value is configured to wake the hardware entity;
configuring a low power mode (LPM) path of the hardware entity according to the deeper idle state when an infinite timer match value is determined; and
setting the residency timer of the hardware entity according to the deeper idle state.

5. The method of claim 1, in which transitioning the hardware entity to the deeper idle state comprises:
detecting expiration of the residency timer during hibernation of the hardware entity according to the selected idle state; and
directing entry of the hardware entity into the deeper idle state.

6. The method of claim 5, further comprising clearing a low power mode (LPM) path of the hardware entity in response to the wake-up of the hardware entity from the deeper idle state.

7. The method of claim 1, in which issuing the WFI comprises:
configuring a low power mode (LPM) path of the hardware entity corresponding to the selected idle state; and
setting the residency timer of the hardware entity according to the deeper idle state.

8. The method of claim 1, in which the transitioning comprises:
detecting expiration of the residency timer during hibernation of the hardware entity according to the selected idle state; and
forcing the wake-up of the hardware entity.

9. The method of claim 1, further comprising:
detecting a rail power collapse idle mode;
configuring a low power mode (LPM) path of the hardware entity corresponding to the deeper idle state; and
directing entry of the hardware entity into the deeper idle state.

10. The method of claim 1, in which the predicted sleep duration of the hardware entity exceeds the sleep duration associated with the selected idle state if the timer associated with the deeper idle state is expired prior to the wake-up of the hardware entity from the selected idle state.

11. An apparatus, comprising:
at least one memory; and
at least one processor coupled to the at least one memory, the at least one processor configured to:
receive an indication of a selected idle state based on a predicted sleep duration of a hardware entity;
issue a wait for interrupt (WFI) instruction to the hardware entity to trigger entry into the selected idle state; and
transition the hardware entity to a deeper idle state if a residency timer associated with the deeper idle state is expired prior to a wake-up of the hardware entity from the selected idle state.

12. The apparatus of claim 11, in which the at least one processor is further configured to force the wake-up of the hardware entity from the selected idle state when the residency timer is expired.

13. The apparatus of claim 11, in which to issue the WFI, the at least one processor is further configured to:
determine, by trusted firmware (TF), if a valid timer match value is configured to wake the hardware entity; and
configure a low power mode (LPM) path of the hardware entity according to the selected idle state when the valid timer match value is determined.

14. The apparatus of claim 11, in which to issue the WFI, the at least one processor is further configured to:
determine, by trusted firmware (TF), if a valid timer match value is configured to wake the hardware entity;
configure a low power mode (LPM) path of the hardware entity according to the deeper idle state when an infinite timer match value is determined; and
set the residency timer of the hardware entity according to the deeper idle state.

15. The apparatus of claim 11, in which to transition the hardware entity to the deeper idle state, the at least one processor is further configured to:
detect expiration of the residency timer during hibernation of the hardware entity according to the selected idle state; and
direct entry of the hardware entity into the deeper idle state.

16. The apparatus of claim 15, in which the at least one processor is further configured to clear a low power mode (LPM) path of the hardware entity in response to the wake-up of the hardware entity from the deeper idle state.

17. The apparatus of claim 11, in which to issue the WFI, the at least one processor is further configured to:
configure a low power mode (LPM) path of the hardware entity corresponding to the selected idle state; and
set the residency timer of the hardware entity according to the deeper idle state.

18. The apparatus of claim 11, in which to transition, the at least one processor is further configured to:
detect expiration of the residency timer during hibernation of the hardware entity according to the selected idle state; and
force the wake-up of the hardware entity.

19. The apparatus of claim 11, in which the at least one processor is further configured to:
detect a rail power collapse idle mode;
configure a low power mode (LPM) path of the hardware entity corresponding to the deeper idle state; and
direct entry of the hardware entity into the deeper idle state.

20. The apparatus of claim 11, in which the predicted sleep duration of the hardware entity exceeds the sleep duration associated with the selected idle state if the residency timer associated with the deeper idle state is expired prior to the wake-up of the hardware entity from the selected idle state.
